(19) United States
(12) Patent Application Publication
(10) Pub. No.: US 2016/0201987 A1
(43) Pub. Date: Jul. 14, 2016

(54) BOX DRYING SYSTEM

(71) Applicant: Troels Jakobsen, Aarhus (DK)

(72) Inventor: Troels Jakobsen, Aarhus (DK)

(21) Appl. No.: 14/903,882

(22) PCT Filed: Jun. 25, 2014
(86) PCT No.: PCT/DK2014/050188

§ 371 Date: Jan. 8, 2016

(30) Foreign Application Priority Data
Jul. 10, 2013 (DK) PA 2013 00418

(51) Int. Cl. F26B 15/18; F26B 5/08

(52) U.S. Cl. CPC F26B 15/18; F26B 5/08

(57) ABSTRACT

The invention concerns a box drying system for drying boxes, e.g. boxes for use in transporting food articles. The box drying system includes at least one box drying line of a plurality of possible box drying lines arranged in parallel, including at least two box drying elements disposed in series along a buffer/feeding track. The feeding path is provided for collecting a number of boxes for drying, wherein the collected boxed for drying are divided into at least two box drying groups, each box drying group comprising at least one box, and wherein drying of the box drying groups is divided between at least two box drying elements. Thereby is achieved a flexible box drying system that may rapidly handle even a large number of boxes.

### FIELD OF THE INVENTION

The present invention concerns a box drying system.

### BACKGROUND OF THE INVENTION

In particular in the food industry and in logistics enterprises that often transport food articles to the retail shops/supermarkets, washing and drying of the food/transport boxes occurs to a great extent. This is done in order to ensure hygiene, quality and shelf life of the foodstuff as well as the visual impression to the user in relation to mainly food article boxes.

Some firms wash millions of such boxes every year. The total number of washings and dryings in the industry is many times greater. Some firms that have box washing as their business wash thousands of boxes an hour at one place at which there may several sites (washing depots) associated with the same firm.

The boxes are typically washed individually, positioned on a continuous path following each other with a small spacing in order for this small spacing to provide space and access to perform nozzle washing of outer box end/gables that otherwise abut each other.

Of methods for drying boxes after washing are known vaporisation, blowing and centrifuging, among others.

Within the latter field it is commonly known that centrifugation, as e.g. by washing clothes in an electric washing machine, can drive accumulated water out of the washed item, in this case food article/transport boxes, typically of plastic and often in the format 600×500/400 mm or 300×400 mm in base dimensions, and with either fixed or foldable box sides. Also larger boxes/containers in the base format of 1000/1200 mm×1200/1000 mm occur. These boxes can be dried using the same principle.

In relation to box washing there are, for example, machines for vertical centrifugation of entire pallets (typically 1200×1000/800 mm base dimension) loaded with stacks (typically 4 or 5 stacks on a pallet) of wet boxes, i.e. with a very high box capacity per time unit due to the collected group of boxes. Fixtures are thus automatically closed around pallet and boxes during rotation such that only water is displaced while pallets/stacks/boxes are retained relative to the mainly vertical axis of rotation.

There are similar machines for vertical centrifugation of single stacks, also with high capacity (typically between 2000 and 10,000 boxes per hour).

The stacking of boxes in a separate box stacking device prior to drying in both of the above mentioned drying machines is effected with regard to drying more boxes in a single cycle consisting of insertion, centrifugation (drying) and extraction, where insertion and extraction are time-consuming processes which all things together counteract the drying time as such and thereby a high number of boxes dried per hour on the machine.

Besides a mechanical or manual stacking device before the drying machine, known principles will suggest that the user performs a possible sorting of various box types before drying, i.e. either sorting of dirty boxes that also smudge the sorting equipment before the box washing machine, or sorting of clean boxes which on the other hand will be wet boxes. These wet boxes can give an inexpedient and in some situations insecure work environment, with e.g. wet, slippery floors in the process and in the area between washing and drying. With e.g. 2,500 wet boxes per hour on a line, or e.g. 5000 boxes from a single washing machine containing two lines, several hundreds litres of water can follow with the boxes from the washing machine per hour.

Alternatively, a stacking of unsorted wet boxes can be performed immediately after washing, and a destacking is then performed again after drying, in order then to perform sorting of the now dry box types that possibly are washed as mixed types. A typewise stacking can then be performed again in yet a stacking device, i.e. there is a potential need for three stacking/destacking devices.

For prior art pallet and stack centrifuges, which initially attempt to manage all boxes in a production line by one and the same centrifugation drive, requiring collection into groups, it is also the case that by the frequently required capacities they are only suited for boxes with foldable/collapsible sides, only measuring a few centimetres (about 3 cm) each in height, which is then constituted by the box bottom itself over which the sides are folded in and laid down, whereby relatively more boxes can be accommodated in a stack (of maximum height normally transported on a pallet and in a normal lorry and trailer).

Higher boxes with fixed, non-collapsible sides would typically take up to 3 to 10 times as much space in height each in a stack and thereby also in a pallet or stack centrifuge, whereby capacity will drop correspondingly on the otherwise relatively expensive machines that i.a. have high capacity per cycle and therefore low energy consumption per box legitimating the investment.

Moreover, the pallet or stack centrifuge is not always optimal in connection with washing and drying why immediately after washing and drying the box where articles are to be put into the box (bread, meat or other), as the box necessarily has been stacked in connection with the drying process and therefore is not immediately accessible for e.g. automatic loading of bread, as in an industrial bakery, without needing destacking again with the associated need for a device or manual handling.

Of centrifugal drying machines there are also types for horizontal centrifugation of an array of successive boxes arriving one by one, not stacked and in a straight line on conveyor lines set up after a washing facility in which boxes are washed continually on a conveyor. In this drying machine, the boxes in one and the same secured fixture are flung around one continuous, substantially horizontal axis.

Both of the prior art types are operated by one central centrifugal drive intended for centrifugation of a plurality of boxes per drive per cycle. There are variants by which two vertical drives—each drive typically intended for one line and one track of washed boxes from the washing machine, and each drive intended for centrifugation of several boxes per cycle—are arranged in parallel, not in series and not in continuation, but side by side in one assembled unit in order to i.a. achieve stability in relation to rotation and vibration in the two parallel individual drives, each centrifuging a considerably greater weight than the weight of single boxes. Thus by assembling two vertical centrifugation axes intended for drying of two box lines, e.g. from a double-tracked washing machine with two lines for washing boxes or the parallel centrifugation drives intended for the interlaced groups of boxes from two tracks from two washing machines, possibly each washing machine with two tracks each, hence four lines in total dried in e.g. two vertical drives. A possible drawback of both vertical and horizontal centrifuges where known variants dry a number of boxes gathered in groups in a stack and in a row, respectively, on one drive, is the risk that failure of parts of the centrifuging mechanism will result in a total stop of drying and thereby washing of boxes on the line in question. And thereby a stop for clean boxes for further distribution or shipping of the user's food articles (e.g. a costly daily production of bread from an industrial bakery if the washer/dryer is installed in a line in such a place).

A user in the food industry could typically and possibly ask for a newly provided machine for a lower number of boxes and thereby a lower total weight of boxes per hour, but rather with a higher number of individual, smaller centrifuge drying units in series and thus with a higher number of drying cycles distributed on the boxes, i.e. possibly one cycle per box and not one cycle per group of a number of stacked boxes. For example, 1000 bread boxes with fixed 150 mm high sides and a weight of 1.5 kg apiece, i.e. 1500 kg/hr, with a low cycle weight, ultimately as low as the weight of a single box plus fixture distributed over 1500 individual drying cycles, in order to make the construction cheaper and minimise the cycle time of each box drying element, including in each drying segment and in each drying unit, which is possible as less mass (kg) is to be supplied in rapid movement, brought rapidly to desired rotational speed and decelerated again, and moved away in connection with each drying cycle in each box drying element.

The prior art centrifuges are initially and for such small tasks (over-)dimensioned weightwise for drying capacities up to e.g. 2500-10,000 foldable boxes of 1-2 kg (2.500-20.000 kg/hr with high cycle weight of totally about 10-10,000 kg including sufficiently strong fixture).

Known variants of centrifugally drying machines for groups, though with one drive only as the important feature of a gathered group of boxes per cycle, are expensive machines, and they are not economical or suitable as to be scaled down in capacity since the highest capacity demands in some parts of the market necessitate that more boxes are collected in groups (stacked or in row) and treated simultaneously in order to minimise the insertion and extraction time in the one drive concerned, and in order not to produce stop in the line behind. The weight of the gathered boxes is continuously increased by each single box and the centrifugal force arising by the flinging of the large mass (kg) requires equipment of substantially solid construction in order to resist the force. To this is added that the equipment and the fixture by themselves will contribute appreciably to dimensions and weight, increasing the weight of the total rotating mass and of the machine as a whole.

### OBJECT OF THE INVENTION

An object of the invention is to provide a box drying system with enhanced flexibility in box drying capacity.

### DESCRIPTION OF THE INVENTION

This is achieved by indicating a method for drying boxes and by providing a box drying system for performing the method such that boxes can be centrifugally dried with good drying results in an energy-saving and quiet way;
without necessarily having to perform stacking of boxes at first;
such that wasted insertion and extraction time for boxes in the drying system is minimised;
in a way leaving layout planning to the user's discretion as to which extent possible sorting of both box heights and types is rather performed after drying (before drying is still a possibility) as each box, according to the invention, can be stored individually and freely accessible (i.e. also not stacked) both before and after drying;
the above additionally providing the user with a maximum degree of freedom for using the washing machine prior to the drying machine as an optimal basis for utilising the washing machine as well without previous sorting of box heights and types that are conveyed through the facility;
in a work-environmentally suitable way where unnecessary handling of wet boxes dripping on floors, etc. is not to be performed;
of various height (high boxes) without reducing capacity in a number of centrifuging actions/dryings per time unit that can remain at maximum;
of various box/side height arriving immediately after each other for drying/centrifuging at the “same” time;
in a system which is suited for boxes with foldable/collapsible sides unfolded and folded as well as suited for boxes with fixed sides, and both variants with different side/box height supplied to the drying system in arbitrary sequence without reducing capacity in the given number of centrifuging/drying actions per time unit that may remain at maximum;
in a system where boxes with foldable sides, if conveyed to the system in folded condition as a number of boxes stacked upon each other, can be dried several at a time in the same one of several possible box drying elements, however without the single box drying element with its centrifugal drying unit capable of managing the total capacity on the actual production line why several box drying elements must be connected in series;
in a physically lighter and more simply scaled device such that the box drying system becomes relatively economically attractive by lower as well as by higher capacities, i.e. the technical solution is to be extended to a lesser degree and with a fewer box drying elements by lower capacity need than by higher capacity need with several box drying elements in series;
in a box drying system with reduced operational wear and maintenance per box drying element as the mass of the rotating fixtures including boxes cause reduced component impact;
in a single or up to several serial and parallel box drying elements such that a box drying element or parts thereof can be in-operative while drying capacity is still maintained in one or more of the other box drying elements.

Moreover, According to the present invention, this is achieved by a box drying system for drying boxes, e.g. boxes for use in transporting food articles, said box drying system including at least one box drying line of a plurality of possible box drying lines arranged in parallel, a buffer/feeding track, a discharge track and positioning mechanisms, for controlling the buffer/feeding and discharge pattern of the boxes, the box drying line including at least two box drying elements disposed in series along the buffer/feeding track and the discharge track respectively, the buffer/feeding track provided for collecting a number of boxes for drying, the discharge track provided for collecting a number of dried boxes, wherein the collected boxes for drying are divided into at least two box drying groups, each box drying group comprising at least one box, and wherein drying of the box drying groups is divided between at least two box drying elements.

According to a further embodiment, the box drying system according to the invention is peculiar in that the drying elements are disposed in series along the discharge track.

According to a further embodiment, the box drying system according to the invention is peculiar in that the positioning mechanisms are selected among guides, pushers and elevators.

In an embodiment of the box drying system according to the invention the positioning mechanisms are selected among box top, bottom or side grip belts, conveyors, guides, flaps, pushers or elevators.

The positioning mechanisms may be arranged such that a given box passes multiple positioning mechanisms on its way through the box drying system.

According to a further embodiment, the box drying system according to the invention is peculiar in that the box drying elements are adapted for drying a number of boxes stacked upon each other.

According to a further embodiment, the box drying system according to the invention is peculiar in that the discharge track is positioned in a position that is vertically higher than the buffer/feeding track and/or horizontally offset from the buffer/feeding track.

It is herewith achieved that the water from the wet boxes does not drip onto the dry boxes. Thus the wet boxes are separated from the dry boxes.

Moreover, it is achieved with a box drying line for use in a box drying system.

Furthermore, it is achieved with a box drying element for use in a box drying system.

Even further, it is achieved with method of drying boxes, e.g. boxes for use in transporting food articles in a box drying system, wherein boxes for drying are feed continuously to a buffer/feeding track in a box drying line, wherein the boxes for drying, on the buffer/feeding track, are continuously divided between at least two box drying groups at collection positions arranged next to a box drying element, wherein upon completion of a box drying group the box drying group is positioned in an empty box drying element using positioning mechanisms and dried, while simultaneously boxes may pass empty collection positions on the buffer/feeding track before arriving at empty downstream collection positions.

It is herewith achieved that boxes that arrive at the box drying line in a variable frequency does not affect the capacity of the system.

When a box drying group leaves a collection position and enters the box drying element, the now empty collection position may be passed by boxes destined for empty downstream collection positions. This increase the capacity of the system, as boxes are moved out of the path of the buffer/discharge track when the box drying element is ready to receive boxes of a completed box drying group.

In an embodiment the method according to the invention is peculiar in that the box drying elements operate simultaneously.

It is herewith achieved that the capacity of the system is maximised. Boxes may pass an up-stream box drying group on their way to an empty down-stream box drying group, while the up-stream box drying group is being dried in the up-stream drying element.

In an embodiment the method according to the invention is peculiar in that the boxes are divided into at least two box drying groups on the discharge track.

It is herewith achieved that the boxes may be buffered on the discharge track.

### DESCRIPTION OF THE DRAWING

Embodiments of the invention are described in the following with reference to:

FIG. 1 shows a box drying system viewed from the box feeding and buffer side, including one box drying line that includes four box drying elements disposed in series.

FIG. 2 shows the box drying system of FIG. 1 as seen from the box extraction and drying side.

FIG. 3 shows the box drying system of FIGS. 1 and 2 as seen from the side as box drying line.

FIG. 4 shows the box drying system of FIGS. 1, 2 and 3 as seen from above as box drying line.

FIG. 5 shows the box drying system of FIGS. 1, 2, 3 and 4 as seen in section as box drying element.

FIG. 6 shows a box drying system viewed from above, including one box drying line that includes four box drying elements arranged in series, wherein the buffer/feeding- and the discharge tracks are offset in a direction out of the plane of the paper, and wherein the direction of movement of boxes along said two tracks is the same.

FIG. 6a shows an embodiment of a box drying system viewed from above, including one box drying line that includes four box drying elements arranged in series, wherein the buffer/feeding- and the discharge tracks are offset in a direction out of the plane of the paper, and wherein the direction of movement of boxes along the discharge track is reversed in relation to the buffer/feeding track.

FIG. 7 shows a box drying system viewed from above, including two box drying lines arranged in parallel and including seven and three box drying elements arranged in series, respectively.

FIG. 8 shows a box drying system viewed from above, including one box drying line that includes four box drying elements arranged in series, wherein the buffer/feeding- and the discharge tracks are located on opposite sides of the box drying elements, and wherein the direction of movement of boxes along said two tracks is the same.

FIG. 9 shows a box drying system viewed from above, including one box drying line that includes four box drying elements arranged in series, wherein the buffer/feeding- and the discharge tracks are located on opposite sides of the box drying elements, and wherein the direction of movement of boxes along the discharge track is reversed in relation to the buffer/feeding track.

FIG. 10 shows a box drying system viewed from above, including one box drying line that includes four box drying elements arranged in series, wherein the buffer/feeding- and the discharge tracks are located on opposite sides of the box drying elements, and wherein the direction of movement of boxes along the discharge track is reversible in relation to the buffer/feeding track.

FIG. 11 shows a box drying system viewed from above, including two parallel box drying line that each includes four box drying elements arranged in series.

### DETAILED DESCRIPTION OF EMBODIMENTS OF THE INVENTION

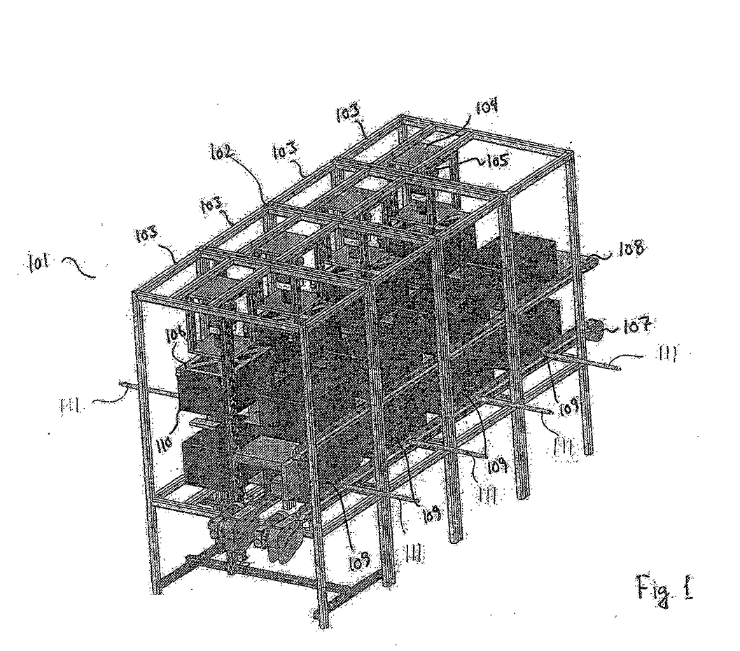

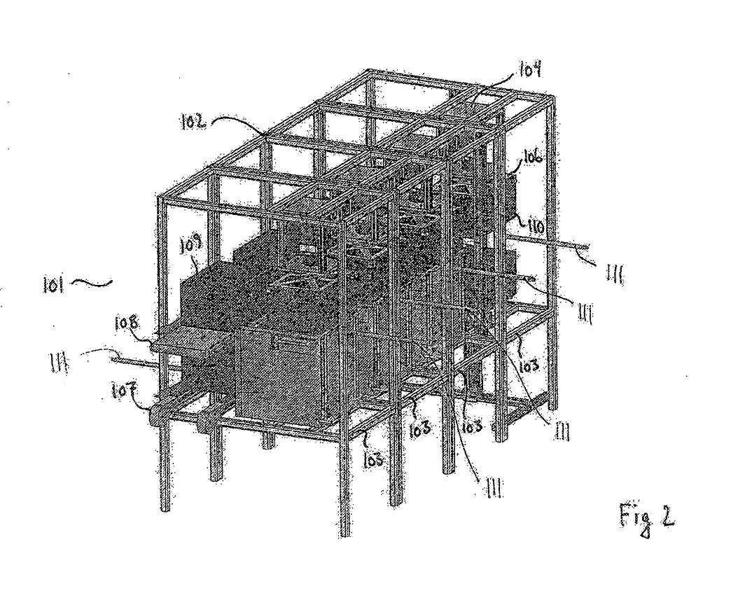

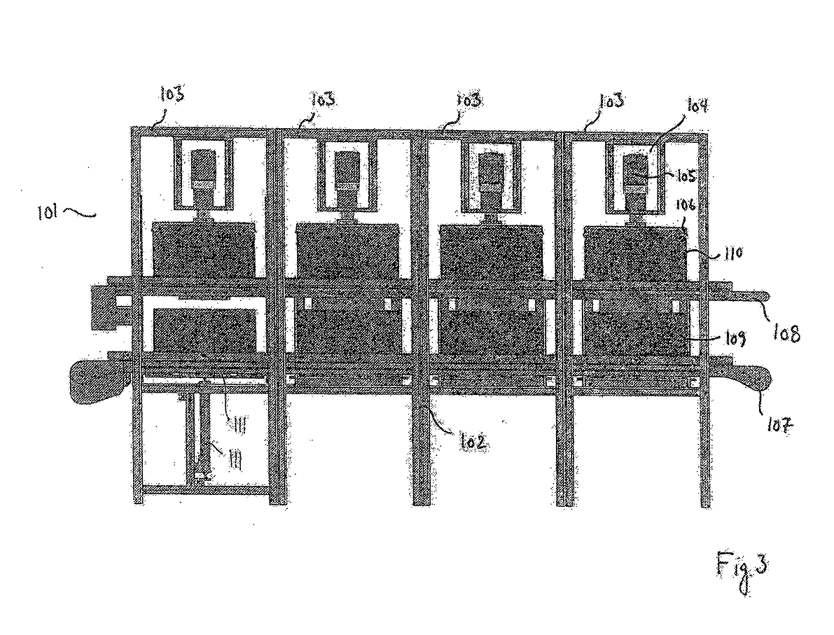

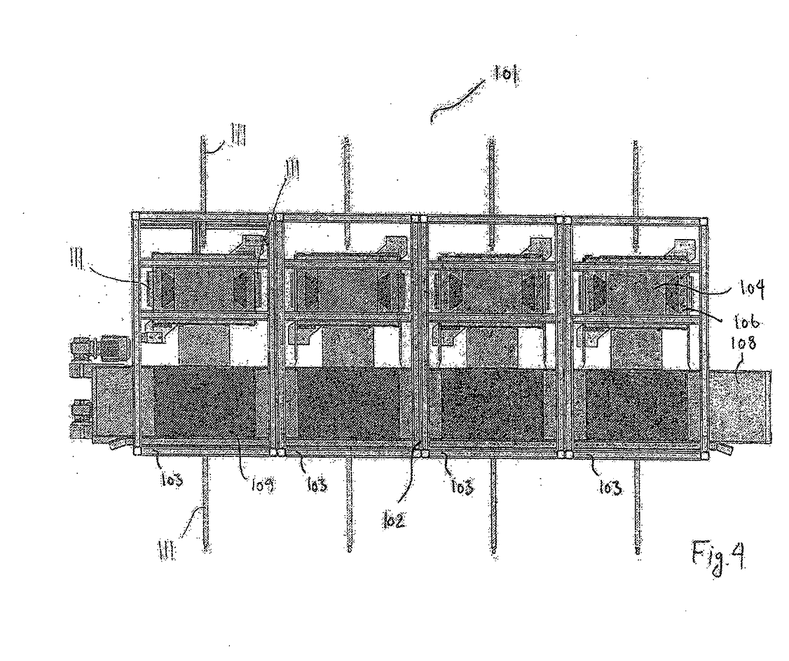

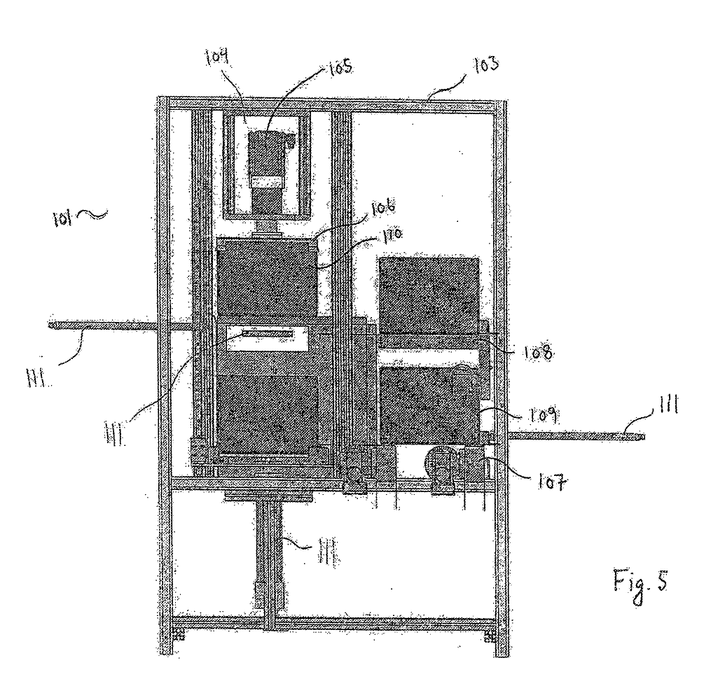

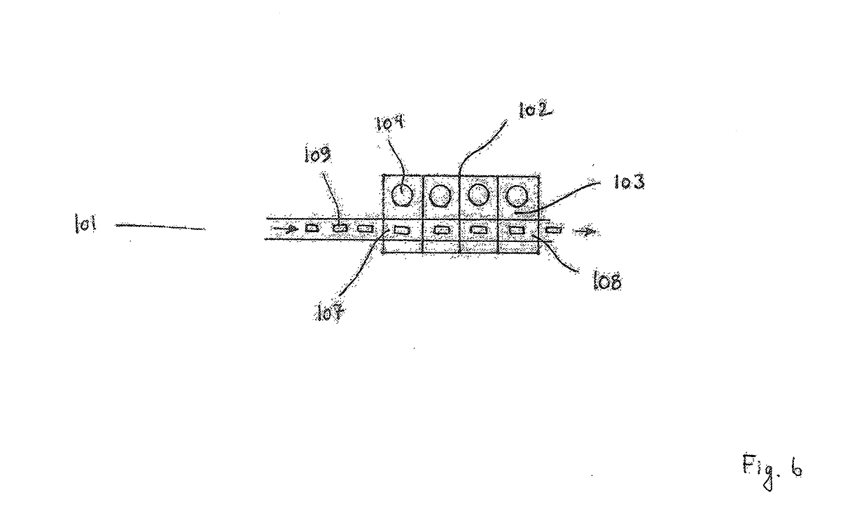

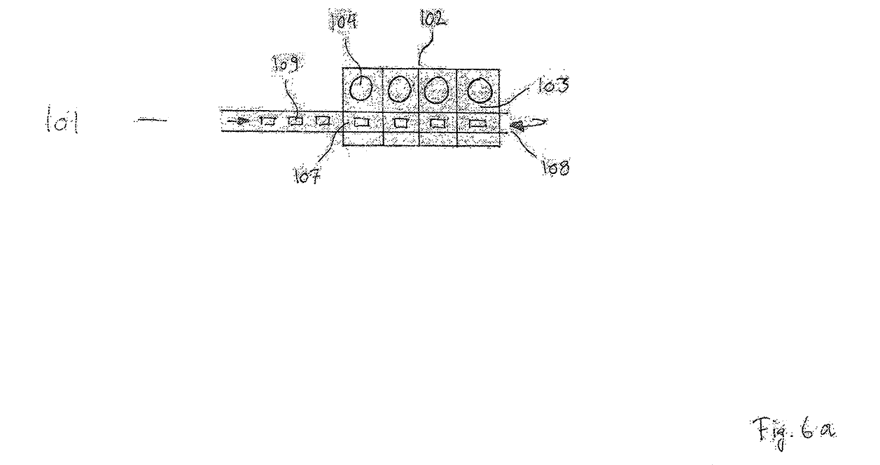

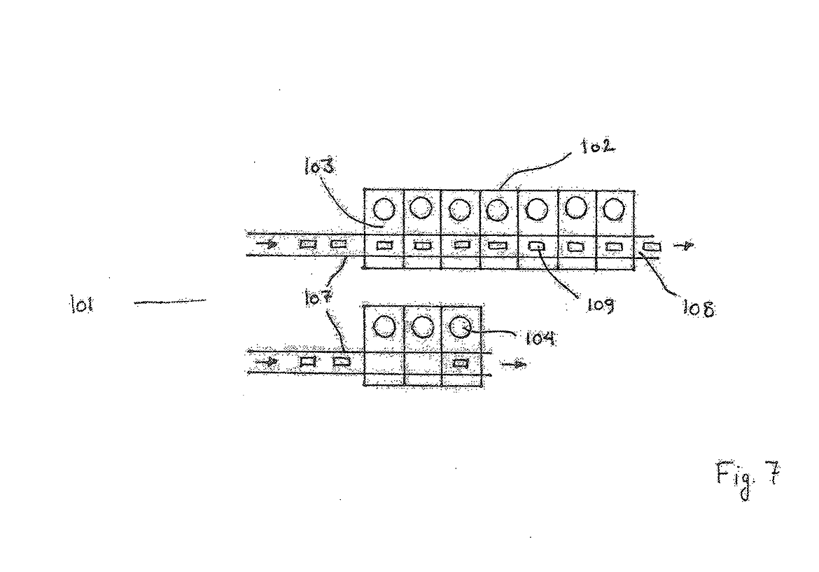

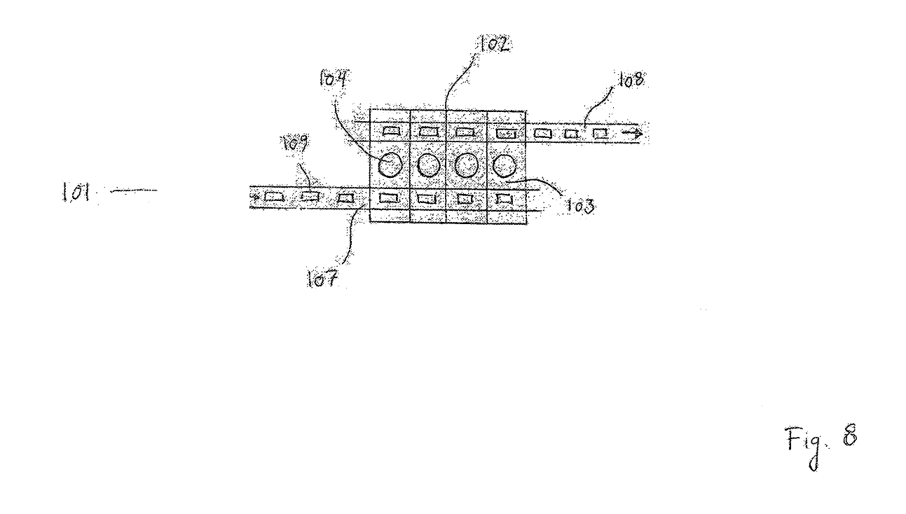

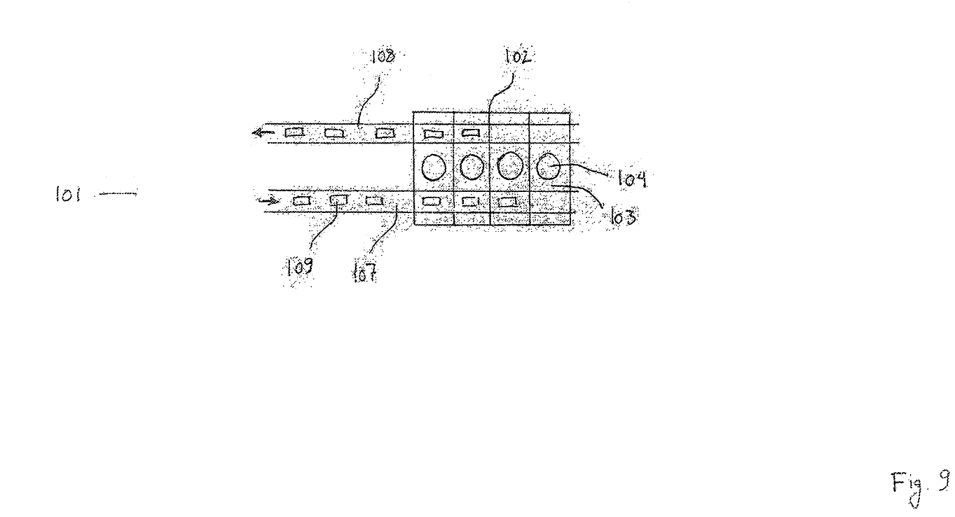

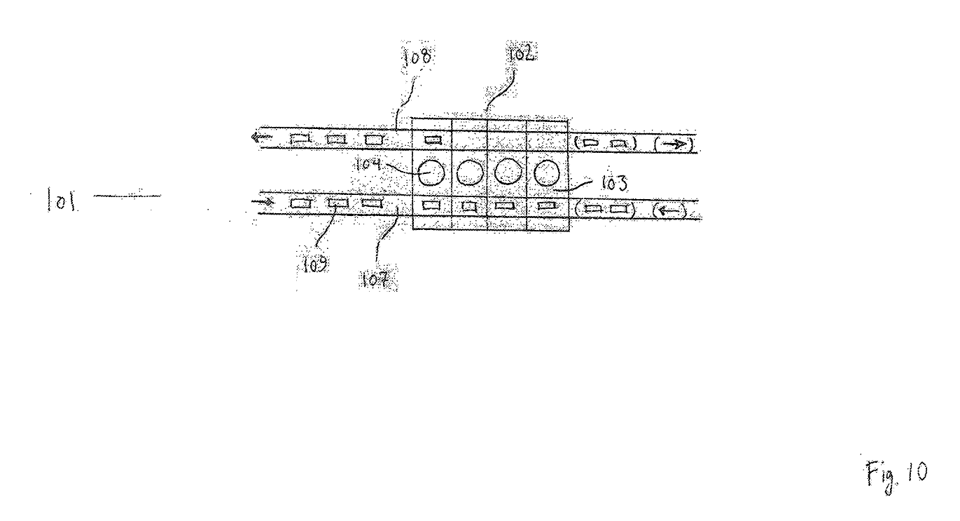

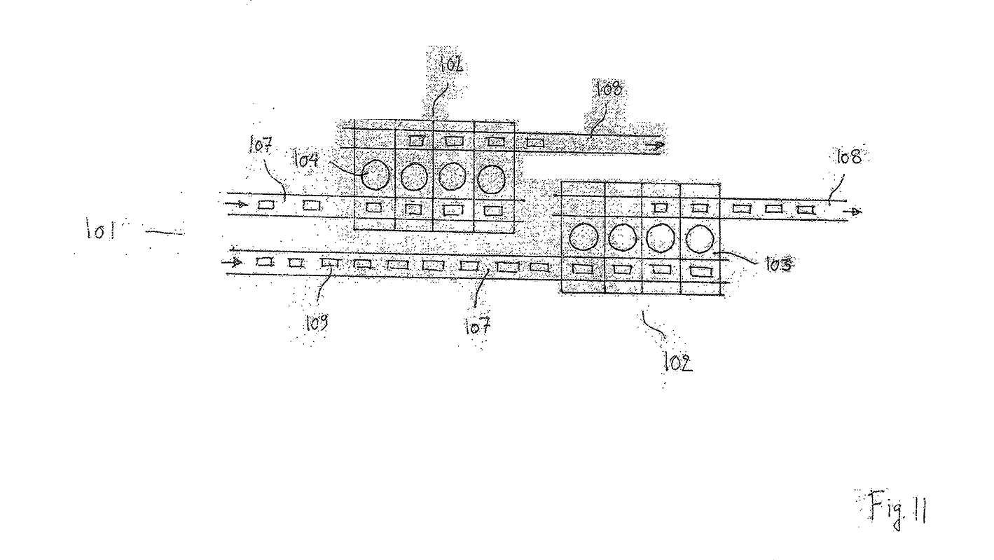

On FIGS. 1-11 are shown a box drying system 101 in which boxes 109 can be dried, one or—in case of boxes with foldable sides and if conveyed to the box drying system 101 in collapsed condition—a number of boxes stacked upon each other, one or more at a time and coordinated among several individual box drying elements 103 in order to attain the desired total number of boxes dried per time unit, as opposed to centrifugation of several boxes stacked or arranged in a row in one single drive as the only one in a system.

The box drying system 101 is built up as an extension principle where actually a single box drying element 103 without being coupled in series is set up for one or for a number of boxes at a time in a situation with need for a relatively low total number of boxes dried per hour, the box drying element 103 in principle having the same technical basis for extension with more individual box drying elements 103 in series as with a box drying line 102 in a situation where the need for a number of boxes dried per hour exceeds the number that can be managed by a single box drying element 103.

Due to its simpler and lighter design, each single box drying element 103 in a box drying line 102 offers a capacity which not in all situations can meet the demands for capacity in a given production line.

A production line may include a box washing machine with one track or from a washing machine with multiple tracks interlaced into one track after the washing. There may also be several washing machines with single or multiple tracks interlaced into one track after the washing.

Besides, the box drying system 101 can overall consist of one or more parallel box drying lines 102, each with one or more box drying elements 103 in a box drying line 102.

Boxes 109 arrive continuously and wet, moving on an external conveyor to a buffer/feeding track 107 which in situations with certain capacity demands also serve as buffer track 107 in order to accumulate a number of boxes before centrifugation/drying, without causing stop on the production up-stream towards a washing machine that is to maintain its continuous operation.

The box drying system 101 thus consists of a number of box drying elements 103, the number depending on capacity/number of boxes per hour in which boxes 109 from buffer/feeding track 107 are moved on one by one, such as perpendicularly, into each their location for positioning and insertion, possibly by being elevated to an overlying box fixture 106 as part of a box drying unit 104 or lowered into an underlying box fixture or displaced into an adjacent box fixture in which boxes are fixed, centrifuged about a vertical or horizontal axis and subsequently conveyed out of the system on a discharge track 108 with various dispositions relative to box drying system 101, box drying line 102, box drying element 103 and box drying unit 104.

In a version for lower capacity, boxes can be conveyed from external conveyor track to buffer/feeding track 107 which moves boxes directly to one or more positions disposed in the same line and at the same level as the buffer/feeding track 107, the same track also serving as discharge track for boxes after completed centrifugation/drying.

The number of box drying elements 103 in a setup can vary from one to a multiple and is determined by the need for a number of dried boxes on a given line or in a given system.

The individual box drying elements 103 can be separate and individual or mounted in series or in parallel in a box drying system 101, or in series and parallel combination.

The box drying system 101 can thus contain a number of motorised box drying units 104 that each can be connected with a drive 105 and with a box fixture 106 which can be rotated.

In a solution there may be used a central motorised drive for rotation of several box fixtures 105 in several box drying units 104 in several box drying elements 103 connected with such a drive.

Box fixtures 106 can either hold boxes 109 with a given base dimension or two boxes with half the base dimension, so-called half-boxes, the boxes designed to be placed as two half-boxes in the space for one whole box (e.g. on a pallet or in a stack).

Conveyance of boxes can occur on a straight track, a curved track or by displacing the box between several over/under or juxtaposed tracks, with box drying elements 103 located in relation thereto.

The box drying system 101 may operate such that one or more box drying elements 103 in a box drying line 102 and box drying units 104 herein operate simultaneously or independently in relation to how and when boxes are moved into the positions in the box drying elements 103. Boxes in several box drying elements 103 and in a box drying line 102 can thereby be centrifuged/dried simultaneously or displaced in time relative to each other, depending on feeding and discharge pattern and movement of possible positioning mechanisms 111, such as guides, pushers and elevators.

For example, a succession of boxes 109 can be conveyed along buffer track/feeding track 107 relative to each their box drying elements 103, after which they are moved on in each their box drying element 103. Each box is simultaneously fixed and simultaneously centrifuged before being moved out and on along discharge track 108. Alternatively, boxes 109 are conveyed in relation to their respective box drying elements 103 and box drying units 104 offset in time relative to other boxes, box drying elements and box drying units in the box drying system 101 in question. The boxes are here centrifuged/dried simultaneously or offset in time, and are extracted simultaneously or offset in time.

For example, a box drying element 103 can initiate moving and drying/centrifugation of a positioned box 110 while a subsequent box arriving along buffer/feeding track 107 is still on its way to a box drying element and the drying unit therein. The feeding, positioning, fixing, centrifugation and discharge of boxes is thus effected her with time displacement in relation to each other in order thereby to avoid waiting time for any boxes arriving, fed, positioned and fixed before others, whereby loss of capacity in the box drying line 102 possibly can be reduced.

Buffer/feeding and discharge tracks 107 and 108 can in some setups also be used as a direct path for boxes around box drying units 104 if no drying is to be performed in a period of time with operation of boxes.

There may be combinations of additional functions for the shown setups and box drying elements 103 can be set up in not shown configurations, possibly with a different disposition of buffer/feeding and discharge tracks 107 and 108 for boxes relative to box drying elements 103.

Tracks and courses in the system can be motorised/driven or not driven in the conveying direction of the boxes, depending on the chosen systematics.

Boxes can be extracted from box drying elements 103 by conveying or by dropping or sliding onto underlying or displaced discharge track collecting the arriving boxes.

Screens for collecting and screening water centrifuged from boxes are built up around rotating fixtures 106 in drying units 104. Screens also serve as safety screening for parts that may fly off the boxes or boxes that possibly due to defects may be loosened from fixtures during centrifugation relative to i.a. the staff staying the area.

Box drying lines 102, box drying elements 103 and box drying units 104 are connected by an electric supply and control system programmed for a desired operational pattern.

After completed treatment, boxes are conveyed from the box drying system 101 along external tracks, typically for sorting, filling or stacking.

1-9. (canceled)

10. A box drying system for drying boxes, e.g. boxes for use in transporting food articles, wherein including at least one box drying line of a plurality of possible box drying lines arranged in parallel, a buffer/feeding track, a discharge track and positioning mechanisms, for controlling the feeding and discharge pattern of the boxes, the box drying line including at least two box drying elements disposed in series along the buffer/feeding track and the discharge track respectively, the buffer/feeding track provided for collecting a number of boxes for drying, the discharge track provided for collecting a number of dried boxes, wherein the box drying system is configured such that the collected boxes for drying are divided into at least two box drying groups, each box drying group comprising at least one box, and wherein drying of the box drying groups is divided between at least two box drying elements.

11. A box drying system according to claim 10, wherein the positioning mechanisms are selected among guides, pushers and elevators.

12. A box drying system according to any of claim 10, wherein the box drying elements are adapted for drying a number of boxes stacked upon each other.

13. A box drying system according to claim 10, wherein the discharge track is positioned in a position that is vertically higher than the buffer/feeding track and/or horizontally offset from the buffer/feeding track.

14. A box drying element for use separately or in a box drying system according to claim 10, wherein the box drying element comprises a buffering/feeding track and a discharge track, where the buffering/feeding track and the discharge track are transporting boxes, where the buffering/feeding track and the discharge track are offset in a manner where the buffering/feeding track and the discharge track are parallel and overlapping.

15. A box drying element according to claim 14, wherein the discharge track is positioned in a position that is vertically higher than the buffer/feeding track and/or horizontally offset from the buffer/feeding track.

16. Method of drying boxes, e.g. boxes for use in transporting food articles in a box drying system, wherein boxes for drying are feed continuously to a buffer/feeding track in a box drying line, wherein the boxes for drying, on the buffer/feeding track, are continuously divided between at least two box drying groups at collection positions arranged next to a box drying element, wherein upon completion of a box drying group the box drying group is positioned in an empty box drying element using positioning mechanisms and dried, while simultaneously boxes may pass empty collection positions on the buffer/feeding track before arriving at empty downstream collection positions.

17. Method according to claim 16, wherein the box drying elements operate simultaneously.

18. Method according to claim 16, wherein the boxes are divided into at least two box drying groups on a discharge track.

19. A box drying system according to any of claim 11, wherein the box drying elements are adapted for drying a number of boxes stacked upon each other.

20. A box drying system according to claim 11, wherein the discharge track is positioned in a position that is vertically higher than the buffer/feeding track and/or horizontally offset from the buffer/feeding track.

21. A box drying system according to claim 12, wherein the discharge track is positioned in a position that is vertically higher than the buffer/feeding track and/or horizontally offset from the buffer/feeding track.

22. A box drying element for use separately or in a box drying system according to claim 11, wherein the box drying element comprises a buffering/feeding track and a discharge track, where the buffering/feeding track and the discharge track are transporting boxes, where the buffering/feeding track and the discharge track are offset in a manner where the buffering/feeding track and the discharge track are parallel and overlapping

23. A box drying element for use separately or in a box drying system according to claim 12, wherein the box drying element comprises a buffering/feeding track and a discharge track, where the buffering/feeding track and the discharge track are transporting boxes, where the buffering/feeding track and the discharge track are offset in a manner where the buffering/feeding track and the discharge track are parallel and overlapping.

24. A box drying element for use separately or in a box drying system according to claim 13, wherein the box drying element comprises a buffering/feeding track and a discharge track, where the buffering/feeding track and the discharge track are transporting boxes, where the buffering/feeding track and the discharge track are offset in a manner where the buffering/feeding track and the discharge track are parallel and overlapping.

25. Method according to claim 17, wherein the boxes are divided into at least two box drying groups on a discharge track.
